(19) United States
(12) Patent Application Publication
(10) Pub. No.: US 2025/0234050 A1
(43) Pub. Date: Jul. 17, 2025

(54) TECHNIQUES FOR AVM COEFFICIENT ENCODING

(71) Applicant: NETFLIX, INC., Los Gatos, CA (US)

(72) Inventors: Rubén ACIEGO CASERO, San Jose, CA (US); Joel SOLE ROJALS, San Diego, CA (US); Xiaoqing ZHU, Austin, TX (US)

(21) Appl. No.: 19/015,460

(22) Filed: Jan. 9, 2025

Related U.S. Application Data
(60) Provisional application No. 63/622,017, filed on Jan. 17, 2024.

(51) Int. Cl. H04N 19/91; H04N 19/124; H04N 19/18

(52) U.S. Cl. CPC H04N 19/91; H04N 19/124; H04N 19/18

(57) ABSTRACT

In various embodiments, computer-implemented method for coding audiovisual content includes identifying a first symbol value included in a block of coefficients, generating a context value for the first symbol value based on a first set of symbol values included in the block of coefficients that reside proximate to a first symbol position associated with the first symbol value, mapping the context value to a first coding parameter using a first mapping table, selecting a first bypass coder from a plurality of bypass coders based on the first symbol value, and executing the first bypass coder on the first symbol value using the first coding parameter to generate a coded version of the first symbol value.

### CROSS-REFERENCE TO RELATED APPLICATIONS

This application claims the benefit of U.S. Provisional Application titled “TECHNIQUES FOR AVM COEFFICIENT ENCODING,” filed on Jan. 17, 2024, and having Ser. No. 63/622,017. The subject matter of this related application is hereby incorporated herein by reference.

### BACKGROUND

### Field of the Various Embodiments

Embodiments of the present disclosure relate generally to computer science and video processing and, more specifically, to techniques for AVM coefficient encoding.

### Description of the Related Art

Modern streaming services implement coding pipelines to efficiently stream audiovisual content associated with media titles to endpoint devices across a network. A coding pipeline generally includes at least one encoder and at least one decoder. To facilitate the streaming of audiovisual content, an encoder performs an encoding process to compress the audiovisual content to a smaller size. The compressed audiovisual content is then transmitted across the network. Upon receipt of the compressed audiovisual data, a decoder performs a decoding process to reconstruct an uncompressed version of the original audiovisual content. Modern streaming services oftentimes implement coding pipelines to conserve network bandwidth and facilitate the timely delivery of audiovisual content to endpoint devices.

A typical encoder implements a multistage process to compress any given frame of audiovisual content. In an initial prediction stage, the encoder performs inter-prediction and/or intra-prediction operations to generate a set of predicted pixel or sample values for a given block of pixel or sample values included in the frame of audiovisual content. The encoder then generates a set of residual values by computing the difference between the set of predicted pixel or sample values and a set of actual pixel or sample values included in the block of pixels or samples. In a subsequent transform stage, the encoder performs a transform operation to convert the set of residual values from the spatial domain to the frequency domain. In doing so, the encoder produces a block of transform coefficients, where each transform coefficient represents the magnitude of a different frequency component in the frequency domain. The encoder then implements a quantization stage where the transform coefficients are rounded to a lower precision and assigned a coefficient index, thereby generating a quantized coefficient.

During a final coding stage, the encoder decomposes each quantized coefficient into several different components. For any given quantized coefficient, one component represents the sign of the quantized coefficient, while the other components represent different, progressively larger, value ranges included in the quantized coefficient. Commonly used ranges include a base range (BR) that includes the lowest bins of a quantized coefficient (e.g., from 0 to 4), a low range (LR) that includes a next set of bins of the quantized coefficient (e.g., from 5 to 7), and a high range (HR) that includes the remaining values of the quantized coefficient. A “bin” refers to a single binary symbol that represents a piece of information within the video data, created through a process called “binarization.” A typical encoder implements multiple low ranges, often referred to as LR1, LR2, LR3, LR4, and so forth. Most of the data resident in a given quantized coefficient is normally included in the BR and LR ranges. Based on the different range components, the encoder then implements entropy coding to encode the BR symbols and the LR symbols, and bypass coding to encode the HR values, thereby generating an encoded version of the quantized coefficient. The encoder repeats this process for each quantized coefficient included in a given block of pixels or samples, and for each block included in the frame of audiovisual content, thereby generating a compressed frame of audiovisual content.

One drawback of the encoding technique described above is that, because most of the data included in a quantized coefficient resides in the BR and LR components, most of the quantized coefficient is encoded using entropy coding. Although entropy coding is generally considered efficient from a compression ratio standpoint, entropy coding is algorithmically complex and therefore computationally intensive and slower than bypass coded bins. Another drawback of the encoding technique described above is that entropy coding symbols is difficult to parallelize, thus further impacting throughput.

As the foregoing illustrates, what is needed in the art are more effective techniques for coding audiovisual content for streaming implementations.

### SUMMARY

In various embodiments, computer-implemented method for coding audiovisual content includes identifying a first symbol value included in a block of coefficients, generating a context value for the first symbol value based on a first set of symbol values included in the block of coefficients that reside proximate to a first symbol position associated with the first symbol value, mapping the context value to a first coding parameter using a first mapping table, selecting a first bypass coder from a plurality of bypass coders based on the first symbol value, and executing the first bypass coder on the first symbol value using the first coding parameter to generate a coded version of the first symbol value.

At least one technical advantage of the disclosed techniques relative to the prior art is that the disclosed techniques enable a greater fraction of audiovisual content to be coded using bypass coding relative to the fraction of audiovisual content that is coded using entropy coding than what is typically achievable using prior art approaches. Because bypass coding is algorithmically simpler and faster to execute than entropy coding, the disclosed techniques enable audiovisual content to be encoded, transmitted, and decoded substantially faster than what is usually achievable using approaches that rely heavily on entropy coding. Another technical advantage of the disclosed techniques is that the disclosed adaptive bypass coder can adaptively transition between different varieties of bypass coding schemes depending on the context associated with a particular symbol. This feature increases the accuracy with which symbols can be coded during bypass coding, while maintaining the simplicity and speed typically associated with bypass coding. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments; and

FIG. 4 is a more detailed block diagram of the endpoint device of FIG. 1, according to various embodiments;

FIG. 5 illustrates an encoding pipeline that resides in the network infrastructure of FIG. 1, according to various embodiments;

FIG. 6 illustrates exemplary transform units generated by the encoding pipeline of FIG. 5, according to various embodiments;

FIG. 7 illustrates exemplary codings of quantized coefficients included in the transform units of FIG. 6, according to various embodiments; and

FIG. 8 is a flow diagram of method steps for adaptively encoding a quantized coefficient, according to various embodiments;

FIG. 9 is a more detailed block diagram of the adaptive bypass coder of FIG. 5, according to various embodiments;

FIG. 10 illustrates a five-neighbor context configuration that can be implemented by the adaptive bypass coder of FIG. 9, according to various embodiments;

FIG. 11 illustrates a three-neighbor context configuration that can be implemented by the adaptive bypass coder of FIG. 9, according to other various embodiments;

FIG. 12 illustrates a modified five-neighbor context configuration that can be implemented by the adaptive bypass coder of FIG. 9, according to other various embodiments; and

FIG. 13 is a flow diagram of method steps for executing adaptive bypass encoding with high range bits of a quantized coefficient, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Modern streaming services implement coding pipelines to efficiently stream audiovisual content associated with media titles to endpoint devices across a network. A coding pipeline generally includes an encoder and a decoder. A typical encoder implements a multistage process to compress frames of audiovisual content. In an initial prediction stage, the encoder generates a set of predicted pixel or sample values for a given block of pixel or sample values. The encoder then computes the difference between the set of predicted pixel or sample values and a set of actual pixel or sample values to generate a set of residual values. In a subsequent transform stage, the encoder transforms the set of residual values from the spatial domain to the frequency domain to generate a block of transform coefficients. The encoder then implements a quantization stage where the transform coefficients are rounded to a lower precision and assigned a coefficient index, thereby generating a quantized coefficient.

During a final coding stage, the encoder decomposes each quantized coefficient into a base range (BR) that includes the lowest-valued portion of the quantized coefficient, a low range (LR) that includes the intermediate values of the quantized coefficient, and a high range (HR) that includes the remaining values of the quantized coefficient. A typical encoder implements multiple low ranges referred to as LR1, LR2, LR3, LR4, and so forth. The encoder then implements entropy coding to encode the BR and the LR symbols, and bypass coding to encode the HR symbols, thereby generating an encoded version of the quantized coefficient.

One drawback of the encoding technique described above is that, because most of the data included in a quantized coefficient resides in the LR symbols, most of the quantized coefficient is encoded using entropy coding. Although entropy coding is generally considered efficient from a compression ratio standpoint, entropy coding is algorithmically complex and therefore computationally intensive and usually quite slow. Further, entropy coding can be difficult to parallelize. Consequently, conventional encoders can introduce a delay when attempting to stream a given media title. Another drawback of the above encoding technique is that portions of compressed audiovisual content encoded using entropy coding can be decoded only by implementing various operations associated with entropy coding in reverse order. Accordingly, conventional decoders usually have to implement some form of reverse entropy coding in order to reconstruct the uncompressed audiovisual content. Consequently, conventional decoders can introduce further delays when attempting to stream a given media title. Given the delays that can occur on both the encoding and decoding sides, coding pipelines that rely heavily on entropy coding cannot always be used to stream audiovisual content in a reliable, timely manner and, therefore, may not be suitable for use when streaming time-sensitive audiovisual content, such as audiovisual content associated with a real-time live event.

To address these issues, a coding pipeline includes an adaptive coder stage that encodes quantized coefficients included in transform units to generate compressed audiovisual content. For a given quantized coefficient that resides in a given transform unit, the adaptive coder stage determines whether the quantized coefficient resides in a low frequency region of the transform unit or a default region of the transform unit. The adaptive coder stage then computes a bypass threshold for the quantized coefficient that determines which bins of the quantized coefficient reside in a base range or a low range, and which bins of the quantized coefficient reside in a high range. The adaptive coder stage then implements an entropy coder to encode the bins of the quantized coefficient that reside in the base range or the low range, and implements an adaptive bypass coder to encode bins of the quantized coefficient that reside in the high range. In various embodiments, multi-symbol entropy coding may be used. The adaptive coder stage determines the bypass threshold based on block parameters associated with the transform unit, the region where the quantized coefficient resides, and other coding parameters, such that the high range includes a greater portion of the coefficient value, and therefore more data, than the base range and the low range combined.

The adaptive bypass coder is configured to encode bits included in the high range of a given quantized coefficient using adaptive bypass coding. For a given set of high range bits, referred to as a symbol N, the adaptive bypass coder analyzes a neighborhood of other symbols proximate to N within the transform unit to generate a context value S. The context value S is derived from a combination of symbol values within the neighborhood. The adaptive bypass coder then maps the context value S to a coding parameter M using a look-up table or other mapping technique. Based on the symbol N and the coding parameter M, the adaptive bypass coder then selects between a first bypass coder that encodes symbols having shorter unary prefixes, and a second bypass coder that encodes symbols having longer unary prefixes. The adaptive bypass coder then configures the selected bypass coder to encode the symbol N, thereby forming a portion of an encoded block of audiovisual content. In various embodiments, M is greater than two, allowing more than two different codes to be used.

At least one technical advantage of the disclosed techniques relative to the prior art is that the disclosed techniques enable a greater fraction of audiovisual content to be coded using bypass coding relative to the fraction of audiovisual content that is coded using entropy coding than what is typically achievable using prior art approaches. Because bypass coding is algorithmically simpler and faster to execute than entropy coding, the disclosed techniques enable audiovisual content to be encoded, transmitted, and decoded substantially faster than what is usually achievable using approaches that rely heavily on entropy coding. Another technical advantage of the disclosed techniques is that the disclosed adaptive bypass coder can adaptively transition between different varieties of bypass coding schemes depending on the context associated with a particular symbol. This feature increases the accuracy with which symbols can be coded during bypass coding, while maintaining the simplicity and speed typically associated with bypass coding. These technical advantages provide one or more technological improvements over prior art approaches.

### System Overview

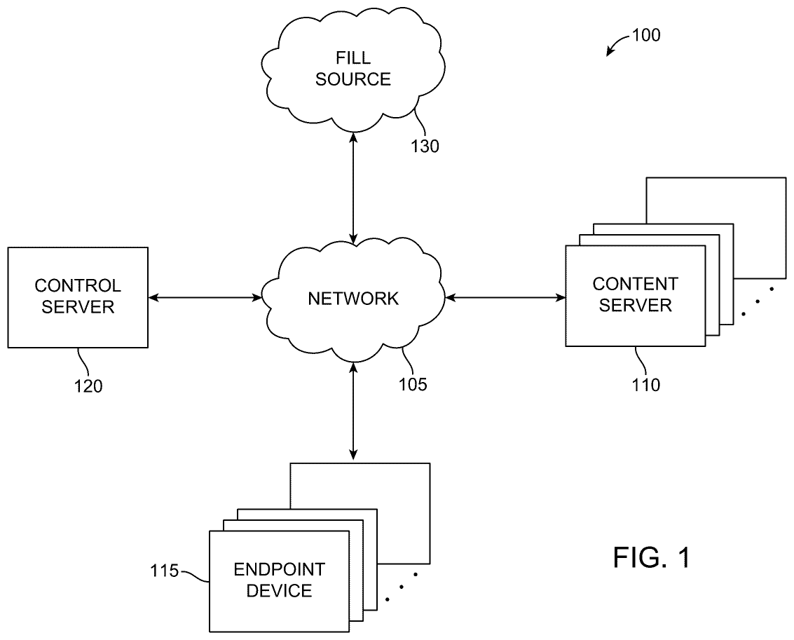

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

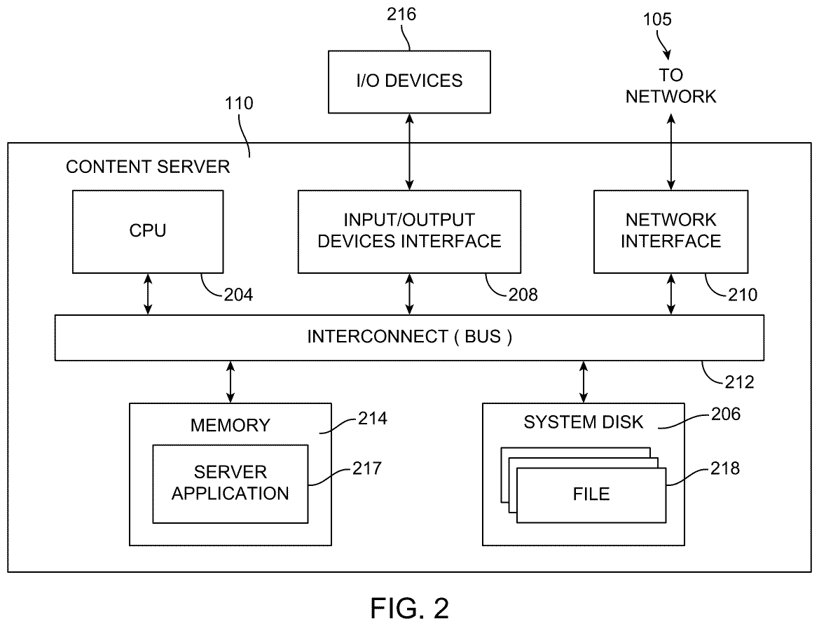

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

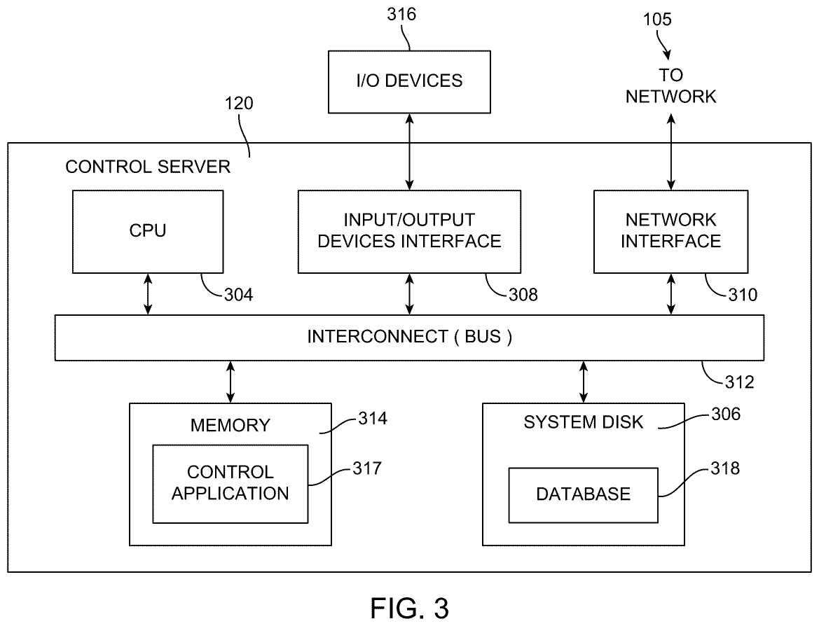

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 206 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

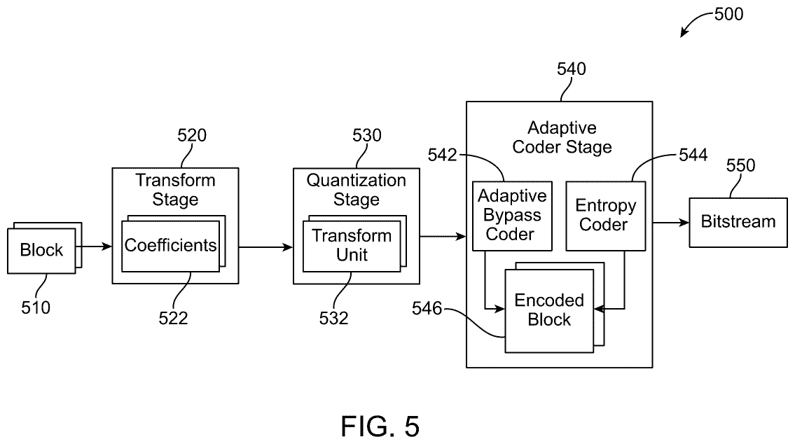

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within system 100, prior to storage. An encoding pipeline configured to perform adaptive encoding is described in greater detail below in conjunction with FIGS. 5-13.

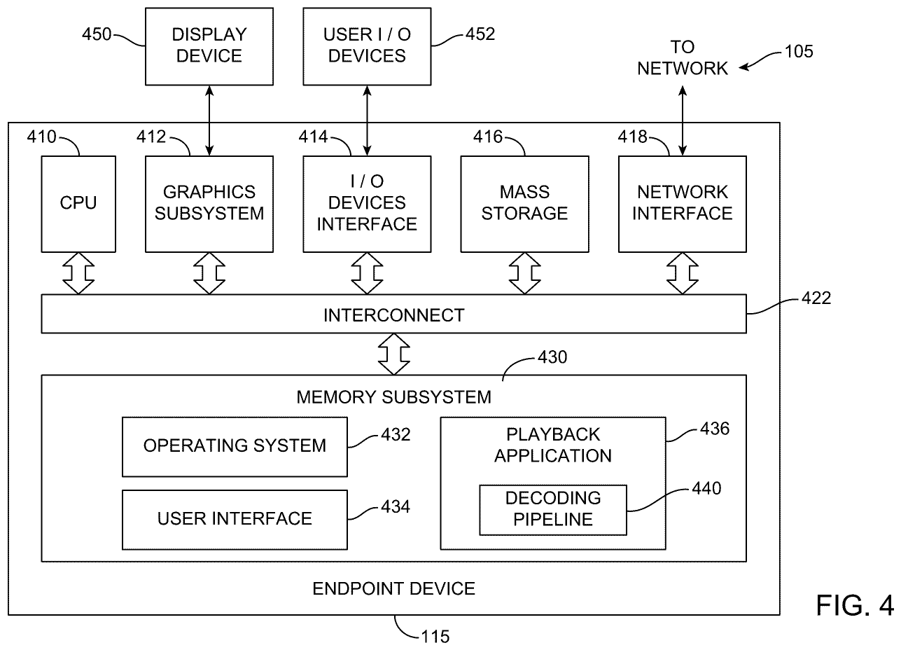

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 105 via the network interface 418. Further, the playback application 436 is configured to interpret the content and present the content via display device 450 and/or user I/O devices 452. In one embodiment, the playback application 436 may include a decoding pipeline that decodes compressed content prior to display via display device. The decoding pipeline implemented by a given endpoint device 115 generally performs operations similar to those described below in conjunction with FIGS. 5-13 relative to various encoding operations, but performed in a reverse and/or inverse manner that allows compressed audiovisual content to be decoded to generate uncompressed audiovisual content.

### AVM Coefficient Encoding

FIG. 5 illustrates an encoding pipeline that resides in the network infrastructure of FIG. 1, according to various embodiments. As shown, the encoding pipeline 500 processes a block 510 of pixel or sample values prior to transmission within bitstream 550. The encoding pipeline 500 includes a transform stage 520, a quantization stage 530, and an adaptive coder stage 540. The adaptive coder stage 540 includes an adaptive bypass coder 542 and an entropy coder 544.

In operation, the transform stage 520 receives the block 510 and performs a transform operation to convert the pixel or sample values included in the block 510 from the spatial domain to the frequency domain. The pixel or sample values included in the block 510 can be associated with any technically feasible color plane, such as luma or chroma, for example and without limitation. In one embodiment, the transform stage 520 may implement a discrete cosine transform (DCT) to transform the pixel or sample values included in the block 510. In other embodiments, any other technically feasible type of transform may be used. The transform stage 520 generates a block of coefficients 520, where each coefficient 520 represents the magnitude and sign of a different frequency in the frequency domain.

The quantization stage 530 receives the coefficients 522 and then performs a quantization operation to round the value of each coefficient 522 to a lower precision. In one embodiment, the quantization stage 530 may further group the rounded values of coefficients 522 according to different ranges and then represent each rounded value with a specific coefficient index associated with the corresponding range. As a general matter, the term quantized coefficient, as referred to herein, may indicate a coefficient that has undergone quantization or an index assigned thereto. The quantization stage 520 generates the transform unit 532, which includes a block of quantized coefficients.

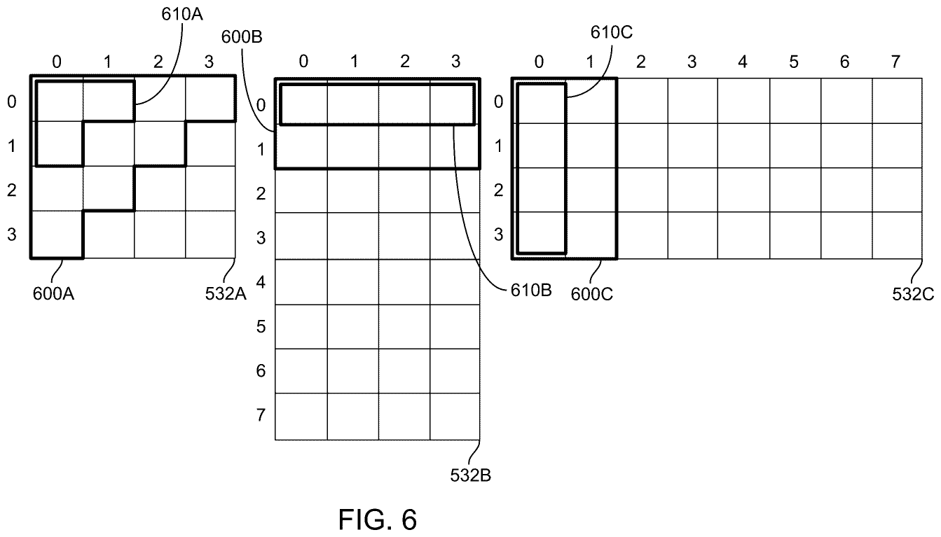

The adaptive coder stage 540 analyzes the transform unit 532 and identifies a low frequency region of quantized coefficients and a default region of quantized coefficients within the transform unit 532. In one embodiment, the low frequency region may include an average coefficient value, referred to as the DC component. In another embodiment, the transform unit 532 may identify a low frequency region of the transform unit 532 based on row indices and column indices associated with the transform unit 532, as described by way of example in conjunction with FIG. 6.

FIG. 6 illustrates exemplary transform units generated by the encoding pipeline of FIG. 5, according to various embodiments. As shown, transform units 532 include low frequency regions 600 and 610. The adaptive coder stage 540 identifies the low frequency regions 600 when the transform unit 532 is derived from a block of pixels or samples in the luma color plane. The adaptive coder stage 540 identifies the low frequency regions 610 when the transform unit 532 is derived from a block of pixels or samples in the chroma color plane.

The transform unit 532A is generated when transform stage 520 implements a two-dimensional (2D) transform. The transform unit 532B is generated when transform stage 520 implements a one-dimensional (1D) vertical transform. The transform unit 532C is generated when the transform stage 520 implements a one-dimensional (1D) horizontal transform. The techniques described herein can be applied to any technically feasible type of transform. The adaptive coder stage 540 identifies low frequency regions 600 or 610 within the transform blocks 532 using any technically feasible approach. However, in the example shown, without limitation, the adaptive coder stage 540 determines the low frequency regions based on the specific transform used to generate the transform unit 532, the color plane associated with the transform unit 532, and a row and column index associated with each cell in the transform unit 532. Table 1 defines the exemplary low frequency regions shown in FIG. 6:

TABLE 1

| | Luma | Chroma |
|---|---|---|
| 2D Transform | Row + Col < 4 | Row + Col < 1 |
| 1D Vertical Transform | Row < 2 | Row < 1 |
| 1D Horizontal Transform | Col < 2 | Col < 1 |

For a given transform unit 532, any cell not included in the low frequency region is considered to belong within the default region. As a general matter, the adaptive coder stage 540 can implement any technically feasible technique for determining the low frequency region and the default region for any given transform unit 532.

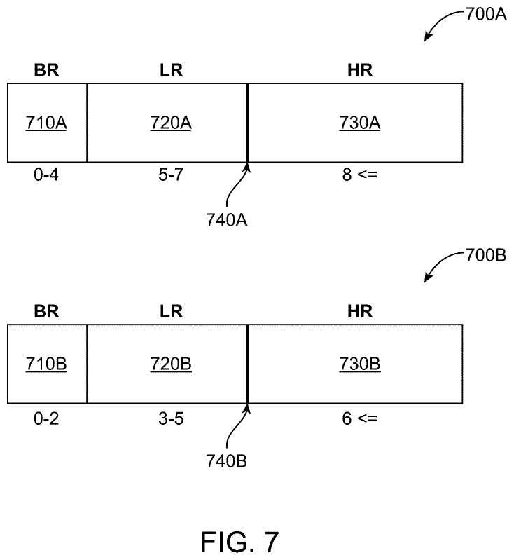

Referring back now to FIG. 5, once the adaptive coder stage 540 determines the low frequency region and the default region for a given transform unit 532, the adaptive coder stage 540 then analyzes each quantized coefficient included in the transform unit 532 and determines, for any given quantized coefficient, a “bypass threshold.” As referred to herein, the bypass threshold for a given quantized coefficient indicates specific value ranges of the quantized coefficient that should be encoded using adaptive bypass coder 542 and other portions of the quantized coefficient that should be encoded using entropy coder 544. In particular, value ranges below the bypass threshold are encoded using entropy coder 544, while the remaining ranges at or above the bypass threshold are encoded using adaptive bypass coder 542, as described in greater detail below in conjunction with FIG. 7.

FIG. 7 illustrates exemplary encodings of quantized coefficients included in the transform units of FIGS. 6, according to various embodiments. As shown, encodings 700 include a base range (BR) 710, a low range (LR) 720, and a high range (HR) 730. The adaptive coding stage 540 implements encoding 700A for quantized coefficients that reside in a low frequency region of the transform unit 532. The encoding 700A includes BR 710A, LR 720A, and HR 730A. The adaptive coding stage 540 implements coding 700B for quantized coefficients that reside in the default region of the transform unit 532. The encoding 700B includes BR 710B, LR 720B, and HR 730B. BR 710, LR 720, and HR 730 generally correspond to specific ranges of bits for any given quantized coefficient.

Each encoding 700 further includes a bypass threshold 740 that determines the relative sizing of the various value ranges. The encoding 700A includes a bypass threshold 740A. In the example shown in FIG. 7, without limitation, the value of the bypass threshold 740A causes LR 720A to represent the value range 5-7 (more specifically, represented in 4 possible symbols: 5, 6, 7, >7) and HR 730A to represent the remaining values at 8 and above. BR 710A represents values in the range of 0-4 (more specifically, in 6 possible symbols: 0, 1, . . . , 4, >4). The encoding 700B includes a bypass threshold 740B. In the example shown in FIG. 7, without limitation, the value of the bypass threshold 740B causes LR 720B to represent value range 3-5 and HR 730B to represent values at 6 and above. BR 710B represents values 0-2. Persons skilled in the art will understand that the ranges shown in FIG. 7 are provided for exemplary purposes only and not meant to limit the scope of the present embodiments. Further, the ranges shown in FIG. 7 generally represent a range of possible integer values for a coefficient index. As a general matter, HR 730 covers a wider range of values than BR 710 and LR 720.

Adaptive coder stage 540 implements entropy coding to encode the portion of a given quantized coefficient that resides in BR 710 and LR 720, and implements adaptive bypass coding to encode the portion of the quantized coefficient that resides in HR 730. Accordingly, the specific value of bypass threshold 740 generated for a particular quantized coefficient determines the fraction of the quantized coefficient that is encoded using entropy coding and the fraction of the quantized coefficient that is encoded using adaptive bypass coding. This approach allows the adaptive coding stage 540 to rely more heavily on adaptive bypass coding when coding conditions allow, thereby facilitating faster encoding and decoding.

The adaptive coder stage 540 generates the bypass threshold for a given quantized coefficient based on block parameters associated with the transform unit 532, the region in the transform unit 532 where the quantized coefficient resides, and/or a coding configuration associated with the encoding pipeline 500. The block parameters associated with transform unit 532 could include, for example and without limitation, a block type, such as intra-block or inter-block, a block dimension, such as block height and/or block width, a transform type used to generate the block, such as 2D, 1 D vertical, or 1D horizontal, or any other technically feasible attribute of the block 510 and/or the transform unit 532. The coding configuration associated with the encoding pipeline 500 could include, for example and without limitation, an encoding mode, a prediction mode, and/or a quantization step size, for example and without limitation. In one embodiment, the coding configuration may further include parameters associated with one or more transform units.

Referring back now to FIG. 5, the adaptive coder stage 540 implements the adaptive bypass coder 542 and the entropy coder 544 based on the bypass threshold 740 generated for each quantized coefficient to generate the encoded block 546. The adaptive bypass coder 542 implements adaptive bypass coding with parts of the quantized coefficient included in HR 730, while the entropy coder 544 implements entropy coding with parts of the quantized coefficient included in BR 710 and LR 720. The encoded block 546 represents a portion of audiovisual content, in compressed form, that can be efficiently transmitted via the bitstream 550 to a given endpoint device 115. The endpoint device 115 can then implement decoding operations derived from the encoding operations described above in order to reconstruct a version of the initial, uncompressed audiovisual content.

As a general matter, balancing bypass coding with entropy coding based on bypass thresholds allows the adaptive coder stage 540 to adaptively leverage bypass coding to a greater extent than entropy coding, thereby expediting the coding process. As known in the art, bypass coding is algorithmically simpler and less computationally intensive compared to entropy coding, and can therefore be performed significantly faster than entropy coding. Accordingly, the disclosed techniques allow audiovisual content to be encoded into a compressed form, and subsequently decoded into an uncompressed form, much faster and with comparable or better quality than possible with conventional techniques.

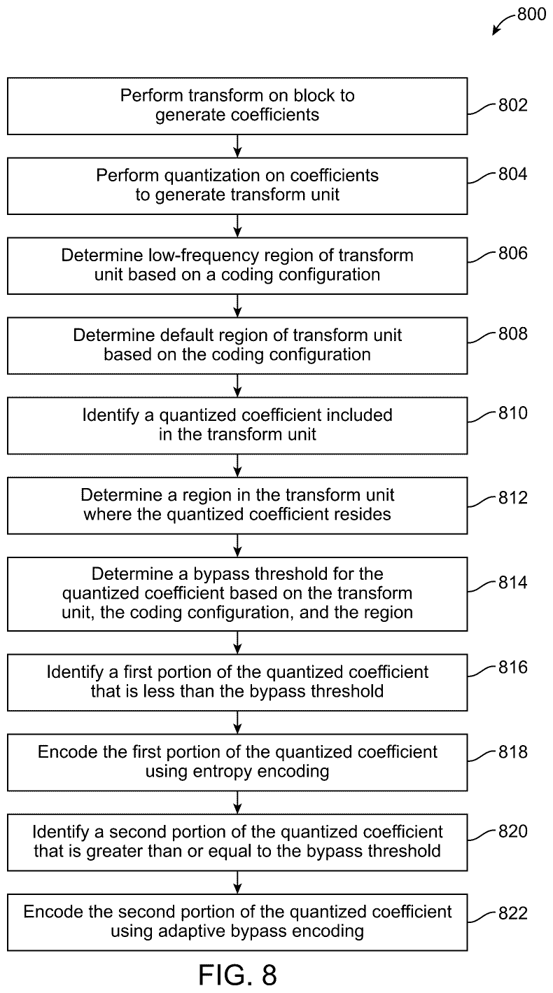

FIG. 8 is a flow diagram of method steps for adaptively encoding a quantized coefficient, according to various embodiments. Although the method steps are described in conjunction with the systems of FIGS. 1-7, persons skilled in the art will understand that any system configured to perform the method steps, in any order, is within the scope of the present invention.

As shown, a method 800 begins at step 802, where the transform stage 520 performs a transform on the block 510 of pixels or samples to generate coefficients 522. In doing so, the transform stage 520 converts pixel or sample values included in the block 510 from the spatial domain to the frequency domain. The pixel or sample values included in the block 510 can be associated with any technically feasible color plane, such as luma or chroma, for example and without limitation. In one embodiment, the transform stage 520 may implement a discrete cosine transform to transform the pixel or sample values included in the block 510. Each coefficient 520 represents the magnitude of a different frequency in the frequency domain.

At step 804, the quantization stage 530 performs a quantization operation on coefficients 522 to generate the transform unit 532. The quantization operation generally involves rounding the value of each coefficient 522 to a lower precision. In one embodiment, the quantization stage 530 may further group the rounded values of coefficients 522 according to different ranges and then represent each rounded value with a specific coefficient index associated with the corresponding range. The quantization stage 520 generates the transform unit 532, which includes a block of quantized coefficients.

At step 806, the adaptive coder stage 540 determines a low-frequency region of the transform unit 532 based on a coding configuration. The coding configuration could, for example and without limitation, include the various mappings set forth above in conjunction with Table 1, although the adaptive coder stage 540 could also implement any technically feasible approach. In various embodiments, the adaptive coder stage 540 may determine low frequency regions based on the specific transform used to generate the transform unit 532, the color plane associated with the transform unit 532, and a row and column index associated with each cell in the transform unit 532. At step 808, the adaptive coder stage 540 determines a default region of the transform unit 532 based on the coding configuration. In one embodiment, adaptive coder stage 540 considers any cell not included in the low frequency region as residing within the default region.

At step 810, the adaptive coder stage 540 identifies a quantized coefficient included in the transform unit 532. In one embodiment, the adaptive coder stage 540 may process quantized coefficients in reverse scan order. At step 812, the adaptive coder stage 540 determines a region in the transform unit where the quantized coefficient resides. In doing so, the adaptive coder stage 540 may implement the mappings set forth in conjunction with Table 1 in conjunction with the row and column indices of a given quantized coefficient in order to determine whether the given quantized coefficient resides in the low frequency region or the default region.

At step 814, the adaptive coder stage 540 determines a bypass threshold 740 for the quantized coefficient based on the transform unit 532, the coding configuration, and the region where the quantized coefficient resides. The bypass threshold 740 for a given quantized coefficient indicates specific ranges of the quantized coefficient that should be encoded using the adaptive bypass coder 542 and other ranges of the quantized coefficient that should be encoded using the entropy coder 544. In particular, the portion below the bypass threshold 740 is encoded using the entropy coder 544, while portion at or above the bypass threshold 740 is encoded using the adaptive bypass coder 542.

At step 816, the adaptive coder stage 540 identifies a first portion of the quantized coefficient that is less than the bypass threshold 740. The first portion generally includes values that fall within BR 710 or LR 720. At step 818, the entropy coder 544 encodes the first portion of the quantized coefficient using entropy encoding.

At step 820, the adaptive coder stage 540 identifies a second portion of the quantized coefficient that is greater than or equal to the bypass threshold 740. The second portion generally includes values that fall within HR 730. HR 730 generally covers a wider range of values than BR 710 and LR 720. At step 822, the adaptive bypass coder 542 encodes the second portion of the quantized coefficient using adaptive bypass encoding.

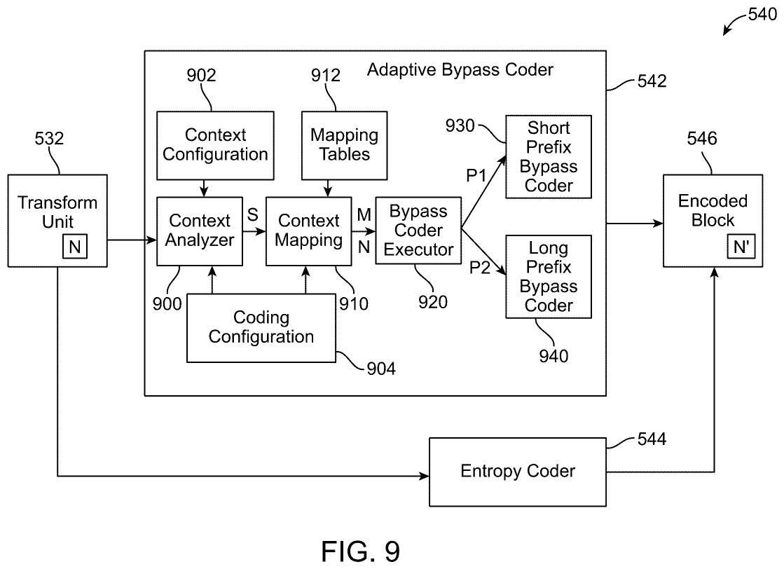

With the disclosed techniques, the adaptive coder stage 540 implements bypass coding techniques, via adaptive bypass coder 542, to encode a larger fraction of quantized coefficients than conventional techniques that rely more heavily on entropy coding techniques. Accordingly, the disclosed coding techniques, when implemented within an encoding pipeline or a decoding pipeline, significantly accelerate the overall coding process, thereby expediting the streaming of audiovisual content. Adaptive bypass coder 542 can implement any technically feasible form of bypass coding. In various embodiments, adaptive bypass coder implements the techniques described below in conjunction with FIGS. 9-13.

### Adaptive Bypass Coding

FIG. 9 is a more detailed block diagram of the adaptive bypass coder of FIG. 5, according to various embodiments. As shown, the adaptive bypass coder 542 includes a context analyzer 900, a context mapping 910, a bypass coder executor 920, a short prefix bypass coder 930, and a long prefix bypass coder 940. The adaptive bypass coder 542 operates on a symbol N that is included in transform unit 532 in order to generate an encoded symbol N^{I} that is included in encoded block 542. The symbol N is a sequence of high range bits that reside in a quantized coefficient included in transform unit 532. The adaptive coder stage 540 identifies the symbol N via the techniques described above in conjunction with FIGS. 5-8. In particular, the adaptive coder stage 540 generates a bypass threshold 740 and then determines the specific bits of the quantized coefficient that reside within HR 730. The entropy coder 544 operates on other portions of the transform unit 532 to generate other portions of the encoded block 542, as also described above in conjunction with FIGS. 5-8.

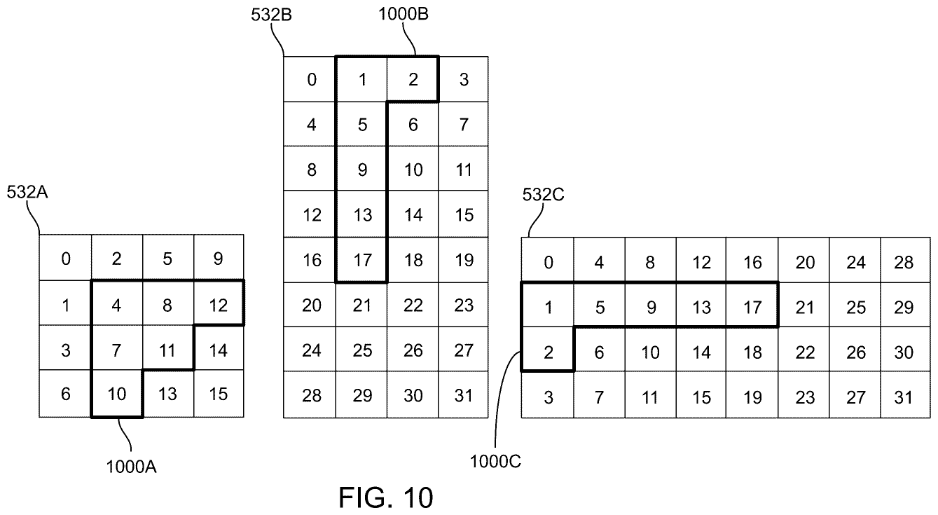

In operation, the adaptive bypass coder 542 receives the transform unit 532 and encodes symbols included in the transform unit 532 in reverse scan order. For example, the adaptive bypass coder 542 could start the encoding process with a symbol that resides in a lower right cell of the transform unit 532, and then work backwards in reverse scan order to a symbol that resides on the upper left cell of the transform unit 532. When encoding the symbol N, the context analyzer 900 uses the values of neighboring symbols in order to generate a context value S. The context value S is a numerical value that represents a neighborhood of the transform unit 532 proximate to the symbol N. The context analyzer 900 generates the context value S based on a context configuration 902 and a coding configuration 904. The context configuration 902 indicates the shape of a specific neighborhood of symbols that reside near to the symbol N, while the coding configuration 904 indicates specific parameters associated with the encoding pipeline 500. FIGS. 10-12 set forth exemplary context configurations, according to various embodiments.

FIG. 10 illustrates a five-neighbor context configuration that can be implemented by the adaptive bypass coder of FIG. 9, according to various embodiments. As shown, various transform units 532 include different context configurations 1000. The various cells of each transform unit 532 are denoted with a numeric value that represents a scan index derived from a scan order. For example, a cell with scan index 0 that resides at the upper left corner of a given transform unit 532 is the first cell in the scan order. The various context configurations 1000 vary in shape based on the specific transform used to generate the corresponding transform unit 532. Transform unit 532A is generated using a 2D transform and includes context configuration 1000A. Transform unit 532B is generated using a 1 D vertical transform and includes context configuration 10001B. Transform unit 532C is generated using a 1 D horizontal transform and includes context configuration 1000C.

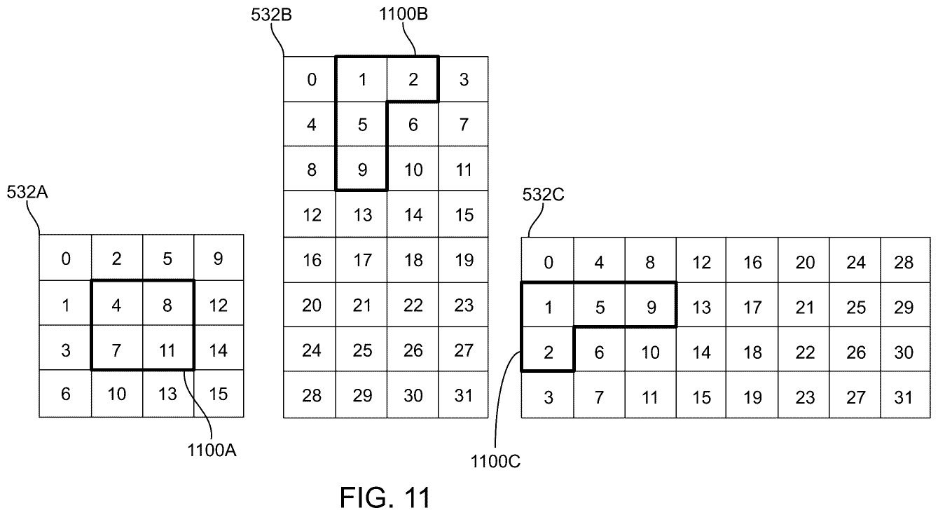

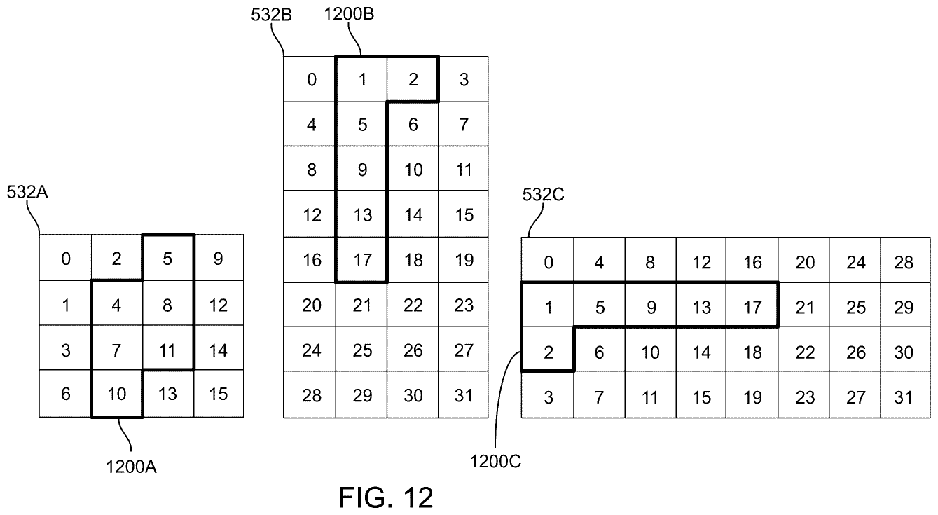

A given context configuration 1000 includes a neighborhood of five symbols proximate to a symbol that resides in the upper-left corner of the context configuration 1000. Context configuration 1000A includes a neighborhood of symbols with scan indices 7, 8, 10, 11, and 12 that reside proximate to a symbol with scan index 4. During encoding of the symbol at scan index 4, context analyzer 900 generates the context value S for that symbol using the values of the symbols at scan indices 7, 8, 10, 11, and 12. Similarly, context configurations 1000B and 1000C both include a neighborhood of symbols with scan indices 2, 5, 9, 13, and 17 that can be used to generate the context value S for the symbol located at scan index 1. FIGS. 11 and 12 set forth alternative neighborhood arrangements, according to various embodiments.

FIG. 11 illustrates a three-neighbor context configuration that can be implemented by the adaptive bypass coder of FIG. 9, according to other various embodiments. As shown, transform unit 532A includes context configuration 1100A that, in turn, includes a neighborhood of symbols with scan indices 7, 8, and 11 that can be used to generate the context value S for the symbol located at scan index 4. Similarly, transform units 532A and 532B include context configurations 1100B and 1100C, respectively, that both include a neighborhood of symbols with scan indices 2, 5, and 9 that can be used to generate the context value S for the symbol located at scan index 1.

FIG. 12 illustrates a modified five-neighbor context configuration that can be implemented by the adaptive bypass coder of FIG. 9, according to other various embodiments. As shown, transform unit 532A includes context configuration 1200A that, in turn, includes a neighborhood of symbols with scan indices 5, 7, 8, 10, and 11 that can be used to generate the context value S for the symbol located at scan index 4. Similarly, context configurations 1200A and 12000 both include a neighborhood of symbols with scan indices 2, 5, 9, 13, and 17 that can be used to generate the context value S for the symbol located at scan index 1.

Referring generally to FIGS. 10-12, the different context configurations shown are provided for exemplary purposes only and are not meant to limit the scope of the present embodiments. In practice, the context analyzer 900 can implement any technically feasible neighborhood of symbols proximate to a given symbol in order to generate a context value S for that symbol. In various embodiments, the neighboring symbols within a given neighborhood may have already undergone encoding via previous passes of the adaptive bypass encoder 542.

Referring back now to FIG. 5, the context analyzer 900 can implement any of the context configurations described above in conjunction with FIGS. 10-12 in order to generate the context value S for the symbol N. When generating the context value S for the symbol N, the context analyzer combines the values of the symbols included in the neighborhood proximate to N via any of several possible techniques. In one embodiment, the context analyzer 900 may compute the absolute sum of the values of the symbols in the neighborhood proximate to N. In another embodiment, the context analyzer 900 may compute a weighted mean of the values of the symbols in the neighborhood proximate to N, normalized based on the maximum value within the neighborhood. In yet another embodiment, the context analyzer 900 may compute the sum of clipped values of the symbols in the neighborhood proximate to N. In yet another embodiment, the context analyzer 900 may compute an exponentially weighted moving average of the values of the symbols preceding ito N, where symbols are weighted based on proximity to N (higher weights assigned to prior symbols closer to N). Persons skilled in the art will understand how any of these techniques can be combined in any technically feasible manner, and can also be applied to neighborhoods having any technically feasible size and/or shape.

In one embodiment, the context analyzer 900 computes the context value S based on a local neighborhood proximate to N, and may then modify that value based on an additional context calculation that involves symbols that reside outside of that neighborhood. In this manner, the context analyzer 900 can incorporate correlations between symbols that reside at other locations within the transform unit 532. In so doing, the context analyzer 900 may compute a moving average of previous symbol values in the scan order via Equation 1:

$$MA ( i ) = \vert q \vert * alfa + MA ( i - 1 ) * ( 1 - alfa ) \qquad ( 1 )$$

In Equation 1, the moving average (MA) at a given position i is computed based on the value q at position i, the previous moving average at a previous position i−1, and a constant factor alfa that is between 0 and 1. Here, q has the value of the symbol N or the value of the unary prefix of the symbol N. Based on the moving average for a given position i, a modified context value S′ can then be computed according to Equation 2:

$${S}^{I} = w * S + ( 1 - w ) * MA ( i - 1 ) \qquad ( 2 )$$

In Equation 2, the value of S can be computed using any of the aforementioned techniques, and then modified based on the moving average of previous symbols. Because the adaptive bypass coder 542 operates in reverse scan order, the moving average at a given position in the transform unit 532 depends on symbols with a higher scan index.

In various embodiments, adaptive bypass coder 542 can select between any of the techniques described above for generating the context value S based on the coding configuration 904. The coding configuration 904 includes various parameters associated with the current configuration of the encoding pipeline 500. For example, the coding configuration 904 could indicate a block size and/or dimension associated with the transform unit 532, a transform type implemented to generate the transform unit 532, one or more quantization parameters, a type of encoding being performed, such as inter-prediction or intra-prediction, or any other technically feasible parameter, without limitation.

Context analyzer 900 generates the context value S using any of the techniques described above and then provides the context value S to context mapping 910. Context mapping 910 generates a coding parameter M based on the context value S, mapping tables 912, and the coding configuration 904. The coding parameter M is used during encoding of the symbol N, as described in greater detail below. The mapping tables 912 include various mappings between different possible values of the context parameter S and different possible coding parameters M. In one embodiment, the mapping tables 912 include Table 2:

TABLE 2

| Value of M | Range of S |
|---|---|
| 1 | S <= 4 |
| 2 | 4 < S <= 8 |
| 3 | 8 < S <= 16 |
| 4 | 16 < S <= 32 |
| 5 | 32 < S <= 64 |
| 6 | 64 < S <= 128 |

Table 2 sets forth specific values of M corresponding to different ranges of S. Those skilled in the art will understand that the specific values shown are provided for exemplary purposes only and are not meant to be limiting. Context mapping 910 can implement a variety of other approaches for generating M as well.

In one embodiment, the context mapping 910 may implement an initial parameter m0 and a finite increasing sequence seq=(n₀, . . . , nₖ), and then compute the coding parameter M as the greatest value such that s<nₙ₋ₘ₀ or m0+k+1 if x>=nₖ, where k is a parameter that depends on the maximum symbol size. Context mapping 910 can perform these computations using the example function code set forth below, without limitation:

```
def get_param(seq, s, m0):
  m = m0
  for n in seq:
    if s < n: break
    m = m+1
  return m
```

In various other embodiments, the context mapping 910 dynamically selects different mapping tables 912 based on parameters associated with the transform unit 532 and/or the coding configuration 904. For example, and without limitation, context mapping 910 could implement one mapping table for DC symbols and another mapping table for non-DC symbols. As known in the art, the term “DC” originates from the term “direct current,” and generally refers to the lowest frequency component in a set of frequency components. Context mapping 910 could further select between these tables based on the current quantization parameter set forth in the coding configuration 904. Context mapping 910 could also implement different mapping tables 912 for different block types, such as inter coded blocks, intra coded blocks, and other types of blocks, without limitation.

In one embodiment, context mapping 910 may evaluate different coding conditions and select between mapping tables depending on which condition is met. Table 3 sets forth example coding conditions and corresponding mapping tables 1-6 that context mapping 910 could implement when the corresponding condition is met, without limitation:

TABLE 3

| Coding Condition | Mapping Table |
|---|---|
| Intra, no DC or QP >= QPₜₕ | 1 |
| Intra, DC and QP < QPₜₕ | 2 |
| Inter, no DC | 3 |
| Inter, DC | 4 |
| Inter, Identify Transform (IDTX) | 5 |
| Inter, Asymmetric Discrete Sine Transform (ADST) | 6 |

In practice, context mapping 910 may implement any subset of the mappings set forth in Table 3. For example, and without limitation, context mapping 910 could implement the mappings associated with mapping tables 1-4, or those associated with mapping tables 1-5, or those associated with mapping tables 1-6. In various other embodiments, context mapping 910 may implement a first mapping table when intra coding is used, a second mapping table when inter coding is used and the IDTX transform is used, and a third mapping table when inter coding is used and the IDTX transform is not used. Context mapping 910 may further implement different tables depending on whether the symbol resides in a low frequency region or a default region. Persons skilled in the art will understand how the different approaches discussed thus far can be combined in any technically feasible fashion. As a general matter, context mapping 910 can select a specific mapping table 912 based on prediction mode, transform type, block size, quantization parameter, frequency region, or any other technically feasible parameter associated with coding.

Context mapping 910 generates the coding parameter M using any of the techniques described above and then provides the coding parameter M to the bypass coder executor 920. The bypass coder executor 920 is configured to process the symbol N and the coding parameter M and to then generate the additional coding parameters K and CMAX. In one embodiment, K and CMAX may be determined via Equations 3 and 4 set forth below:

$$K = M + 1 \qquad ( 3 )$$

$$CMAX = min ( 4 + M , 6 ) \qquad ( 4 )$$

In various other embodiments, the coder bypass executor 920 sets K equal to M, sets K equal to a constant value, or sets CMAX equal to a constant value. Based on the values of N, M, and CMAX, the bypass coder executor 920 then determines whether the symbol N should be encoded using the short prefix bypass coder 930 or the long prefix bypass coder 940. In particular, the bypass coder executor 920 computes the unary prefix length of N and implements the short prefix bypass coder 930 to encode N when the unary prefix length is below CMAX, and implements the long prefix bypass coder 940 to encode N when the unary prefix length is greater than or equal to CMAX. Bypass coder executor 920 can execute the short prefix bypass coder 930 to encode N based on parameters P1, thereby generating N′ within encoded block 542. The parameters P1 include the symbol N and the coding parameter M. Alternatively, bypass coder executor 920 can execute the long prefix bypass coder 940 to encode N based on parameters P2, thereby generating N′ within encoded block 542. The parameters P2 include N, M, K, and CMAX.

In one embodiment, the bypass coder executor 920 may implement Truncated Rice coding, the short prefix bypass coder 930 may implement Golomb-Rice coding, and the long prefix bypass coder 940 may implement Exponential Golomb (Exp-Golomb) Coding. Further, the coding parameter M may be a Rice parameter, the coding parameter K may be an Exp-Golomb parameter, and the coding parameter CMAX may be a maximum unary prefix length. The encoded symbol N′ may then be determined using the example function code below, without limitation:

```
def truncated_rice(N, M, K, CMAX):
  q = N >> M
  if q >= CMAX:
    code = CMAX * ‘1’ + exp_golomb(N − CMAX*2**M, K)
  else:
    code = golomb_rice(N, M)
  return code
```

As a general matter, the bypass coder executor 920 can implement any technically feasible approach to selecting between the short prefix bypass coder 920 and the long prefix bypass coder 940 based on the various parameters discussed thus far. Further, the short prefix bypass coder 930 and the long prefix bypass coder 940 can implement any technically feasible approaches to coding symbol values having different unary prefix lengths.

Referring generally to FIGS. 9-12, with the disclosed techniques, the adaptive bypass coder 542 can efficiently code high range symbols associated with a given quantized coefficient (or index thereof). Further, these techniques can be combined with the approach described above in conjunction with FIGS. 5-8 in order to facilitate bypass coding of a larger portion of a given quantized coefficient. In particular, quantized coefficients (or indices thereof) can be quickly and efficiently encoded by implementing the bypass threshold 740 described in conjunction with FIG. 7 to determine HR 730, and then encoding symbols derived from HR 730 via the adaptive bypass coder 542. With this combined approach, quantized coefficients can be more effectively encoded and decoded compared to conventional coding techniques.

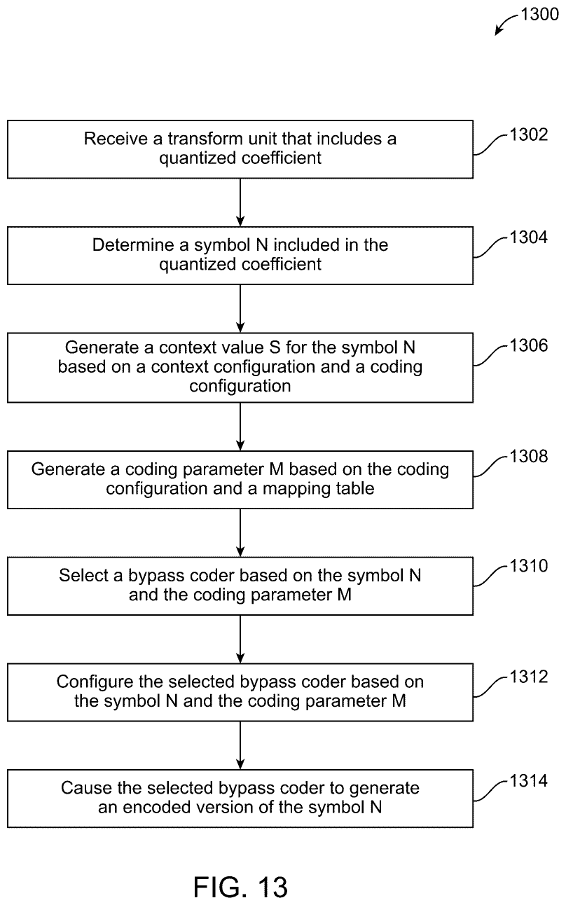

FIG. 13 is a flow diagram of method steps for executing adaptive bypass encoding with high range bits of a quantized coefficient, according to various embodiments. Although the method steps are described in conjunction with the systems of FIGS. 1-12, persons skilled in the art will understand that any system configured to perform the method steps, in any order, is within the scope of the present invention.

As shown, a method 1300 begins at step 1302, where the adaptive coder stage 540 receives a transform unit 532 that includes a quantized coefficient. The quantization stage 530 generates the transform unit 532 and quantized coefficient by performing a quantization operation based on coefficients 522. In one embodiment, the quantization stage 530 performs step 804 of the method 800 to generate the quantized coefficient. In some implementations, the transform unit 532 includes coefficient indices that represent different ranges of quantized coefficients.

At step 1304, the adaptive coder stage 540 determines a symbol N included in the quantized coefficient. The adaptive coder stage 540 determines the symbol N based on a bypass threshold 740 generated for the quantized coefficient. In one embodiment, the adaptive coder stage 540 may perform step 820 of the method 800 to determine the symbol N. The symbol N generally includes high range bits of the quantized coefficient that reside within HR 730.

At step 1306, the context analyzer 900 within the adaptive bypass coder 542 generates a context value S for the symbol N based on the context configuration 902 and the coding configuration 904. The context configuration 902 indicates a specific pattern of neighbors proximate to the symbol N within the transform unit 532. FIGS. 10-12 set forth exemplary neighborhoods that context analyzer 900 can implement when generating the context value S. When computing the context value S, the context analyzer can implement any technically feasible approach for combining the values of other symbols within the neighborhood proximate to the symbol N. For example, and without limitation, the context analyzer 900 could compute a weighted sum or weighted average of symbol values within the neighborhood. The context analyzer could further incorporate symbol values falling outside of the neighborhood in order to capture long-range correlations between symbol values. The context analyzer 900 can further implement the coding configuration 904 when computing the context value S. The coding configuration 904 could indicate, for example, a block size and/or dimension associated with the transform unit 532, a transform type implemented to generate the transform unit 532, one or more quantization parameters, a type of encoding being performed, such as inter-prediction or intra-prediction, or any other technically feasible parameter, without limitation.

At step 1308, context mapping 910 within the adaptive bypass coder 542 generates a coding parameter M based on the context value S, the coding configuration and a mapping table. Context mapping 910 generally implements the mapping table described above in conjunction with Table 1 in order to map specific values of S to specific values of M. In various other embodiments, context mapping 910 dynamically selects different mapping tables 912 based on parameters associated with the transform unit 532 and/or the coding configuration 904. For example, and without limitation, context mapping 910 could implement one mapping table for DC symbols and another mapping table for non-DC symbols. Context mapping 910 could further select between these tables based on the current quantization parameter set forth in the coding configuration 904. Context mapping 910 could also implement different mapping tables 912 for different block types, such as inter coded blocks, intra coded blocks, and other types of blocks, without limitation.

At step 1310, the bypass coder executor 920 within the adaptive bypass coder 542 selects between the short prefix bypass coder 930 and the long prefix bypass coder 940 based on the symbol N and the coding parameter M. The bypass coder executor 920 is configured to process the symbol N and the coding parameter M and to then generate the additional coding parameters K and CMAX. Then, the bypass coder executor 920 computes the unary prefix length of N and selects the short prefix bypass coder 930 to encode N when the unary prefix length is below CMAX, and selects the long prefix bypass coder 940 to encode N when the unary prefix length is greater than or equal to CMAX. In one embodiment, the bypass coder executor 920 may implement Truncated Rice coding.

At step 1312, bypass coder executor 920 configures the selected bypass coder based on the symbol N and the coding parameter M. Bypass coder executor 920 can configure the short prefix bypass coder 930 to encode the symbol N based on parameters P1 that include the symbol N and the coding parameter M. Alternatively, bypass coder executor 920 can configure the long prefix bypass coder 940 to encode the symbol N based on parameters P2 that include N, M, K, and CMAX. In one embodiment, the short prefix bypass coder 930 may implement Golomb-Rice coding, the long prefix bypass coder 940 may implement Exponential Golomb Coding, the coding parameter M may be a Rice parameter, and the coding parameter K may be an Exp-Golomb parameter.

At step 1314, the bypass coder executor 920 causes the selected bypass coder to generate an encoded version of the symbol N, shown in FIG. 9 as N^{I}. The encoded version resides in encoded block 542. The encoding process described above can be repeated for any number of different symbols in order to generate encoded versions of those symbols. Once populated with those encoded versions of symbols, the encoded block 542 can be transmitted within bitstream 550 to an endpoint device 115. The endpoint device 115 can then decode the encoded block 542 using the coding techniques described herein in order to generate a portion of audiovisual content.

As a general matter, the techniques described above in conjunction with FIGS. 5-13 can be combined in any technically feasible manner in order to encode and decode audiovisual content. Further, the processes described above in conjunction with FIGS. 8 and 13 can be combined in any technically feasible fashion in order to dynamically modify the proportion of quantized coefficients that are encoded using entropy coding versus bypass coding, as described in conjunction with FIG. 8, and to also improve the coding efficiency of bypass coding through adaptive techniques, as described above in conjunction with FIG. 13.

In sum, a coding pipeline includes an adaptive coder stage that encodes quantized coefficients included in transform units to generate compressed audiovisual content. For a given quantized coefficient that resides in a given transform unit, the adaptive coder stage determines whether the quantized coefficient resides in a low frequency region of the transform unit or a default region of the transform unit. The adaptive coder stage then computes a bypass threshold for the quantized coefficient that determines which portions of the quantized coefficient reside in a base range or a low range, and which portions of the quantized coefficient reside in a high range. The adaptive coder stage then implements an entropy coder to encode the symbols representing the part of the quantized coefficient that reside in the base range or the low range, and implements an adaptive bypass coder to encode the remaining part of the quantized coefficient that reside in the high range. The adaptive coder stage determines the bypass threshold based on block parameters associated with the transform unit, the region where the quantized coefficient resides, and other coding parameters.

The adaptive bypass coder is configured to encode the high range portion of a given quantized coefficient using adaptive bypass coding. For a given high range value, referred to as a symbol N at position i, the adaptive bypass coder analyzes a neighborhood of previously coded symbols proximate to position i within the transform unit to generate a context value S. The context value S is derived from a combination of symbol values within the neighborhood. The adaptive bypass coder then maps the context value S to a coding parameter M using a look-up table or other mapping technique. Based on the symbol N and the coding parameter M, the adaptive bypass coder then selects between a first bypass coder that encodes symbols having shorter unary prefixes, and a second bypass coder that encodes symbols having longer unary prefixes. The adaptive bypass coder then configures the selected bypass coder to encode the symbol N, thereby forming a portion of an encoded block of audiovisual content.

At least one technical advantage of the disclosed techniques relative to the prior art is that the disclosed techniques enable a greater fraction of audiovisual content to be coded using bypass coding relative to the fraction of audiovisual content that is coded using entropy coding than what is typically achievable using prior art approaches. Because bypass coding is algorithmically simpler and faster to execute than entropy coding, the disclosed techniques enable audiovisual content to be encoded, transmitted, and decoded substantially faster than what is usually achievable using conventional approaches that rely heavily on entropy coding. Another technical advantage of the disclosed techniques is that the disclosed adaptive bypass coder can adaptively transition between different varieties of bypass coding depending on the context associated with a particular symbol. This feature increases the accuracy with which symbols can be coded during bypass coding, while maintaining the simplicity and speed typically associated with bypass coding. These technical advantages provide one or more technological improvements over prior art approaches.

1. Various embodiments include a computer-implemented method for coding audiovisual content, the method comprising identifying a first symbol value included in a block of coefficients, generating a context value for the first symbol value based on a first set of symbol values included in the block of coefficients that reside proximate to a first symbol position associated with the first symbol value, mapping the context value to a first coding parameter using a first mapping table, selecting a first bypass coder from a plurality of bypass coders based on the first symbol value, and executing the first bypass coder on the first symbol value using the first coding parameter to generate a coded version of the first symbol value.

2. The computer-implemented method of clause 1, wherein generating the context value for the first symbol value comprises generating a first combined value based on the first set of symbol values, generating a second combined value based on a second set of symbol values, wherein the second set of symbol values includes the first set of symbol values as well as a third set of symbol values, and generating a weighted sum of the first combined value and the second combined value.

3. The computer-implemented method of any of clauses 1-2, wherein generating the context value for the first symbol value comprises computing an absolute sum of the first set of symbol values or computing an exponentially weighted average of the first set of symbol values.

4. The computer-implemented method of any of clauses 1-3, wherein generating the context value for the first symbol value comprises computing a moving average of the first set of symbol values, wherein the first set of symbol values includes all previously coded symbol values.

5. The computer-implemented method of any of clauses 1-4, wherein mapping the context value to the first coding parameter comprises determining a first range of values included in the mapping table, and determining that the first range of values corresponds to the first coding parameter.

6. The computer-implemented method of any of clauses 1-5, further comprising selecting the first mapping table from a plurality of mapping tables based on a prediction mode used to generate the block of coefficients.

7. The computer-implemented method of any of clauses 1-6, further comprising selecting the first mapping table from a plurality of mapping tables based on a transform type used to generate the block of coefficients or a quantization parameter used to generate the block of coefficients.

8. The computer-implemented method of any of clauses 1-7, further comprising selecting the first mapping table from a plurality of mapping tables based on a scan index associated with the first symbol value.

9. The computer-implemented method of any of clauses 1-8, further comprising determining a unary prefix length associated with the first symbol value, wherein the first bypass coder is selected based further on the unary prefix length.

10. The computer-implemented method of any of clauses 1-9, wherein the first bypass coder implements Rice-Golomb coding.

11. The computer-implemented method of any of clauses 1-10, wherein the first bypass coder implements Exponential-Golomb coding.

12. Various embodiments include one or more non-transitory computer-readable media including instructions that, when executed by one or more processors, cause the one or more processors to code audiovisual content by performing the steps of identifying a first symbol value included in a block of coefficients, generating a context value for the first symbol value based on a first set of symbol values included in the block of coefficients that reside proximate to a first symbol position associated with the first symbol value, mapping the context value to a first coding parameter using a first mapping table, selecting a first bypass coder from a plurality of bypass coders based on the first symbol value, and executing the first bypass coder on the first symbol value using the first coding parameter to generate a coded version of the first symbol value.

13. The one or more non-transitory computer-readable media of clause 12, wherein the step of generating the context value for the first symbol value comprises generating a first combined value based on the first set of symbol values, generating a second combined value based on a second set of symbol values, wherein the second set of symbol values includes the first set of symbol values as well as a third set of symbol values, and generating a weighted sum of the first combined value and the second combined value.

14. The one or more non-transitory computer-readable media of any of clauses 12-13, wherein generating the context value for the first symbol value comprises computing an absolute sum of the first set of symbol values.

15. The one or more non-transitory computer-readable media of any of clauses 12-14, wherein generating the context value for the first symbol value comprises computing an exponential weighted average of the first set of symbol values.

16. The one or more non-transitory computer-readable media of any of clauses 12-15, wherein the step of mapping the context value to the first coding parameter comprises determining a first range of values included in the mapping table, and determining that the first range of values corresponds to the first coding parameter.

17. The one or more non-transitory computer-readable media of any of clauses 12-16, further comprising the step of selecting the first mapping table from a plurality of mapping tables based on a prediction mode used to generate the block of coefficients.

18. The one or more non-transitory computer-readable media of any of clauses 12-17, further comprising the step of selecting the first mapping table from a plurality of mapping tables based on at least one of a transform type used to generate the block of coefficients, a quantization parameter used to generate the block of coefficients, or a scan index associated with the first symbol value.

19. The one or more non-transitory computer-readable media of any of clauses 12-18, further comprising the step of determining a unary prefix length associated with the first symbol value, wherein the first bypass coder is selected based further on the unary prefix length.

20. The one or more non-transitory computer-readable media of any of clauses 12-19, wherein the first bypass coder implements Rice-Golomb coding or Exponential-Golomb coding.

21. Various embodiments include a system comprising one or more memories storing instructions, and one or more processors coupled to the one or more memories that, when executing the instructions, perform the steps of identifying a first symbol value included in a block of coefficients, generating a context value for the first symbol value based on a first set of symbol values included in the block of coefficients that reside proximate to a first symbol position associated with the first symbol value, mapping the context value to a first coding parameter using a first mapping table, selecting a first bypass coder from a plurality of bypass coders based on the first symbol value, and executing the first bypass coder on the first symbol value using the first coding parameter to generate a coded version of the first symbol value.

Any and all combinations of any of the claim elements recited in any of the claims and/or any elements described in this application, in any fashion, fall within the contemplated scope of the present invention and protection. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for coding audiovisual content, the method comprising:
identifying a first symbol value included in a block of coefficients;
generating a context value for the first symbol value based on a first set of symbol values included in the block of coefficients that reside proximate to a first symbol position associated with the first symbol value;
mapping the context value to a first coding parameter using a first mapping table;
selecting a first bypass coder from a plurality of bypass coders based on the first symbol value; and
executing the first bypass coder on the first symbol value using the first coding parameter to generate a coded version of the first symbol value.

2. The computer-implemented method of claim 1, wherein generating the context value for the first symbol value comprises:
generating a first combined value based on the first set of symbol values;
generating a second combined value based on a second set of symbol values, wherein the second set of symbol values includes the first set of symbol values as well as a third set of symbol values; and
generating a weighted sum of the first combined value and the second combined value.

3. The computer-implemented method of claim 1, wherein generating the context value for the first symbol value comprises computing an absolute sum of the first set of symbol values or computing an exponentially weighted average of the first set of symbol values.

4. The computer-implemented method of claim 1, wherein generating the context value for the first symbol value comprises computing a moving average of the first set of symbol values, wherein the first set of symbol values includes all previously coded symbol values.

5. The computer-implemented method of claim 1, wherein mapping the context value to the first coding parameter comprises:
determining a first range of values included in the mapping table; and
determining that the first range of values corresponds to the first coding parameter.

6. The computer-implemented method of claim 1, further comprising selecting the first mapping table from a plurality of mapping tables based on a prediction mode used to generate the block of coefficients.

7. The computer-implemented method of claim 1, further comprising selecting the first mapping table from a plurality of mapping tables based on a transform type used to generate the block of coefficients or a quantization parameter used to generate the block of coefficients.

8. The computer-implemented method of claim 1, further comprising selecting the first mapping table from a plurality of mapping tables based on a scan index associated with the first symbol value.

9. The computer-implemented method of claim 1, further comprising determining a unary prefix length associated with the first symbol value, wherein the first bypass coder is selected based further on the unary prefix length.

10. The computer-implemented method of claim 1, wherein the first bypass coder implements Rice-Golomb coding.

11. The computer-implemented method of claim 1, wherein the first bypass coder implements Exponential-Golomb coding.

12. One or more non-transitory computer-readable media including instructions that, when executed by one or more processors, cause the one or more processors to code audiovisual content by performing the steps of:
identifying a first symbol value included in a block of coefficients;
generating a context value for the first symbol value based on a first set of symbol values included in the block of coefficients that reside proximate to a first symbol position associated with the first symbol value;
mapping the context value to a first coding parameter using a first mapping table;
selecting a first bypass coder from a plurality of bypass coders based on the first symbol value; and
executing the first bypass coder on the first symbol value using the first coding parameter to generate a coded version of the first symbol value.

13. The one or more non-transitory computer-readable media of claim 12, wherein the step of generating the context value for the first symbol value comprises:
generating a first combined value based on the first set of symbol values;
generating a second combined value based on a second set of symbol values, wherein the second set of symbol values includes the first set of symbol values as well as a third set of symbol values; and
generating a weighted sum of the first combined value and the second combined value.

14. The one or more non-transitory computer-readable media of claim 12, wherein generating the context value for the first symbol value comprises computing an absolute sum of the first set of symbol values.

15. The one or more non-transitory computer-readable media of claim 12, wherein generating the context value for the first symbol value comprises computing an exponential weighted average of the first set of symbol values.

16. The one or more non-transitory computer-readable media of claim 12, wherein the step of mapping the context value to the first coding parameter comprises:
determining a first range of values included in the mapping table; and
determining that the first range of values corresponds to the first coding parameter.

17. The one or more non-transitory computer-readable media of claim 12, further comprising the step of selecting the first mapping table from a plurality of mapping tables based on a prediction mode used to generate the block of coefficients.

18. The one or more non-transitory computer-readable media of claim 12, further comprising the step of selecting the first mapping table from a plurality of mapping tables based on at least one of a transform type used to generate the block of coefficients, a quantization parameter used to generate the block of coefficients, or a scan index associated with the first symbol value.

19. The one or more non-transitory computer-readable media of claim 12, further comprising the step of determining a unary prefix length associated with the first symbol value, wherein the first bypass coder is selected based further on the unary prefix length.

20. The one or more non-transitory computer-readable media of claim 12, wherein the first bypass coder implements Rice-Golomb coding or Exponential-Golomb coding.

21. A system comprising:
one or more memories storing instructions; and
one or more processors coupled to the one or more memories that, when executing the instructions, perform the steps of:
identifying a first symbol value included in a block of coefficients,
generating a context value for the first symbol value based on a first set of symbol values included in the block of coefficients that reside proximate to a first symbol position associated with the first symbol value,
mapping the context value to a first coding parameter using a first mapping table,
selecting a first bypass coder from a plurality of bypass coders based on the first symbol value, and
executing the first bypass coder on the first symbol value using the first coding parameter to generate a coded version of the first symbol value.
